(19) United States
(12) Patent Application Publication
(10) Pub. No.: US 2019/0375241 A1
(43) Pub. Date: Dec. 12, 2019

(54) HIGH PERFORMANCE AGRICULTURAL TIRE

(71) Applicant: Bridgestone Americas Tire Operations, LLC, 200 4th Avenue South, TN (US)

(72) Inventors: Jacob L. Walters, Medina, OH (US); Benjamin E. Rimai, Copley, OH (US); Chad J. Kresge, Clover, SC (US); Lisa M. Dinger, Brunswick, OH (US); Matthew W. Thomas, Madison, TN (US); Matthew L. Cardinale, Johnston, IA (US); Jason J. Para, Franklin, TN (US)

(73) Assignee: Bridgestone Americas Tire Operations, LLC, 200 4th Avenue South, TN (US)

(21) Appl. No.: 16/481,895

(22) PCT Filed: Jan. 25, 2018
(86) PCT No.: PCT/US2018/015168

§ 371 Date: Jul. 30, 2019

Related U.S. Application Data
(60) Provisional application No. 62/452,553, filed on Jan. 31, 2017.

(51) Int. Cl. B60C 9/00; B60C 9/20

(52) U.S. Cl. CPC B60C 9/0042; B60C 2009/209; B60C 2200/08; B60C 9/20

(57) ABSTRACT

An agricultural tire includes a toroidal tire structure containing vulcanized rubber in an amount of about 90 percent or more by weight. The tire structure may have one or more performance enhancing features, including high strength plies. The high strength plies contain cords that are formed of yarns, including polyamide yarns, and have individual cord tensile strengths within a range of about 400 N to about 700 N. The performance enhancing features further include circumferential belt plies having cords at angles of about 74 degrees or more from an axial direction.

### TECHNICAL FIELD

This technology relates to the structure and composition of agricultural (Ag) tires.

### BACKGROUND

Ag tires are typically operated under conditions that differ substantially from those encountered by passenger tires and other non-Ag tires. Ag tires may thus have structural features, such as treads, belt plies, and body plies that are configured for performance characteristics uniquely required by Ag tires.

### SUMMARY

An Ag tire includes a toroidal tire structure containing vulcanized rubber in the amount of about 90 percent or more by weight. The tire structure may have one or more performance enhancing features, including high strength plies. The high strength plies contain cords that are formed of yarns, including polyamide yarns, and have individual cord tensile strengths within a range of about 400 N to about 700 N. The performance enhancing features further include circumferential belt plies having cords at angles of about 74 degrees or more from an axial direction. In particular examples, the polyamide yarns may have deniers within the range of about 1500 to about 1900. The cord angles may be within a range of about 74 degrees to about 90 degrees from an axial direction.

### BRIEF DESCRIPTION OF THE DRAWINGS

FIG. 1 is a sectional view of an Ag tire.

FIG. 2 is a schematic view of a part of the tire of FIG. 1.

FIG. 3 is a view similar to FIG. 2, showing a tire in an alternate embodiment.

### DETAILED DESCRIPTION

The structures illustrated in the drawings include examples of the elements recited in the claims. The illustrated structures thus include examples of how a person of ordinary skill in the art can make and use the claimed invention. These examples are described to meet the enablement and best mode requirements of the patent statute without imposing limitations that are not recited in the claims. One or more of the elements of one embodiment may be used in combination with, or as a substitute for, one or more elements another as needed for any particular implementation of the invention.

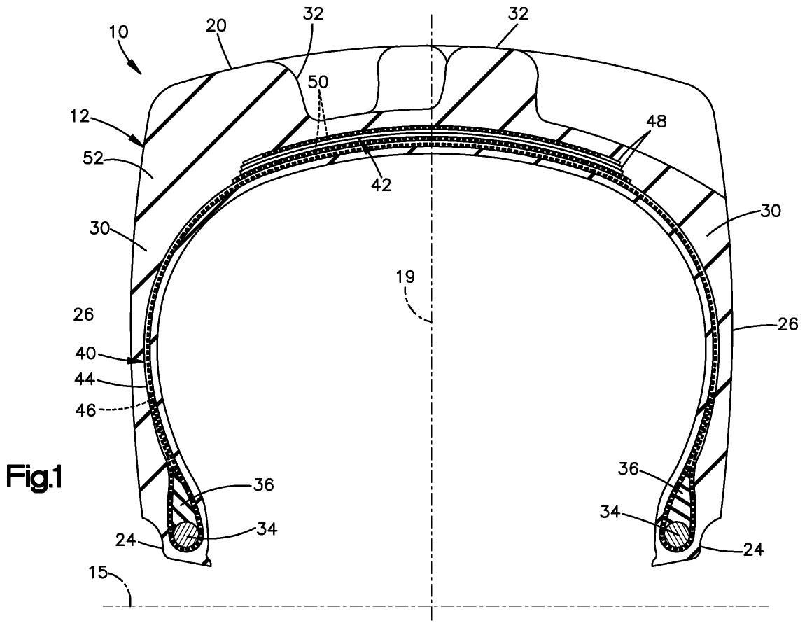

As shown for example in the embodiment of FIG. 1, an Ag tire 10 includes a toroidal tire structure 12 having an axis of rotation 15. The tire structure 12 reaches circumferentially about the axis 15, and is substantially symmetrical about an equatorial plane 19 perpendicular to the axis 15. Major portions of the tire structure 12 include a tread 20, a pair of beads 24, and opposite sidewalls 26.

Each bead 24 includes a bead core 34 and an apex strip 36. The tread 20 extends laterally across the equatorial plane 19 between a pair of shoulder portions 30 at the upper ends of the sidewalls 26. In the illustrated embodiment, the tread 20 includes circumferentially staggered lugs 32 converging axially and circumferentially toward the equatorial plane 19. Such treads are shown, for example, in U.S. Pat. Nos. 8,905,097 and 9,073,389, which are incorporated by reference.

Other portions of the tire structure 12 include a carcass 40 and a belt layer 42. The carcass 40 comprises body plies 44 of rubber-coated cords 46, which as shown partially in FIG. 1, reach radially between and around the beads 24. The belt layer 42 comprises belt plies 48 of rubber-coated cords 50 extending circumferentially over the body plies 44. The sidewalls 26 extend over the carcass structure 40 radially from the beads 24 to the shoulder portions 30 of the tread 20.

The tread 20, the beads 24, and the sidewalls 26 together enclose the other components of the tire structure 12 within a continuous body 52 of vulcanized rubber. As an Ag tire, the tire 10 has a tread 20 that is substantially larger, both actually and proportionately, than a tread normally found on a passenger tire or other non-Ag tires. The entire body 52 of vulcanized rubber is likewise larger than non-Ag counterparts. As a result, vulcanized rubber provides about 90 percent or more of the total weight of the tire 10, and is preferably within a range of about 90 to about 95 percent of the total weight of the tire 10, whereas non-Ag tires are known to include vulcanized rubber in lesser amounts.

As a performance-enhancing feature, the tire structure 12 is provided with high strength plies. These may be provided as either body plies 44 or belt plies 48, or as both body plies 44 and belt plies 48. High strength plies may include only radial body plies 44. High strength plies may include only circumferential belt plies 48. In each case, the high strength plies contain cords that are formed of yarns, including polyamide yarns, and have individual cord tensile strengths within a range of about 400 N to about 700 N. Such individual cord tensile strengths may be obtained by including polyamide yarns having deniers within the range of about 1500 to about 1900.

For example, specific constructions may include:

(1) Polyester cords made from 4 yarns each having 1500 denier (1500/4) with a total cord tensile strength of at least 445 N.

(2) Polyester cords made from 6 yarns each having 1500 denier (1500/6) with a total cord tensile strength of at least 647 N.

(3) Nylon 66 cords made from 4 yarns each having 1900 denier (1900/4) with a total cord strength of at least 599 N.

In the given example of a tire structure 12, the carcass 40 and the belt layer 42 include only the high strength plies. Each ply 44 and 48 contains only cords 46 or 50 that are formed entirely of polyamide yarns having deniers within the range of about 1500 to about 1900.

Stated more specifically, in this example of a tire structure 12, both the body plies 44 and the belt plies 48 are all high strength plies. The high strength plies 44 and 48 contain only cords that are formed of yarns, including polyamide yarns, and that have individual cord tensile strengths within a range of about 400 N to about 700 N. The polyamide yarns have deniers within the range of about 1500 to about 1900. The high strength plies include cords in which the yarns consist of polyamide yarns having deniers within the range of about 1500 to about 1900, and include plies in which all cords are formed of yarns consisting of polyamide yarns having deniers within the range of about 1500 to about 1900.

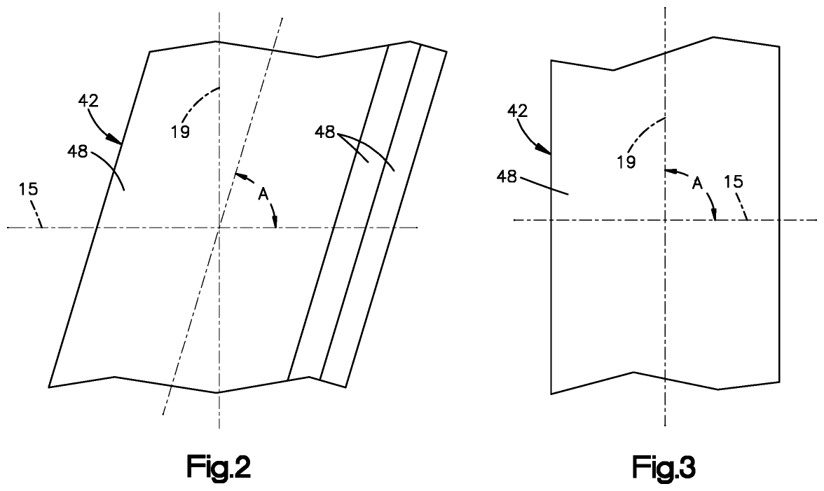

As another performance-enhancing feature, any one or more of the belt plies 48 may have a cord angle A of about 74 degrees or more from the direction of the axis 15, as indicated schematically in FIG. 2. In the illustrated tire structure 12, each belt ply 46 has a cord angle within a range of about 74 degrees to about 90 degrees from the axial direction.

In another embodiment, the belt layer 42 consists of only a single belt ply 48 reaching in the circumferential direction, i.e. with a cord angle A equal or substantially equal to 90 degrees from the axial direction, as shown partially in FIG. 3. The single belt ply 48 is preferably constructed as a high strength ply as described above.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” To the extent that the term “substantially” is used in the specification or the claims, it is intended to take into consideration the degree of precision available or prudent in manufacturing. To the extent that the term “selectively” is used in the specification or the claims, it is intended to refer to a condition of a component wherein a user of the apparatus may activate or deactivate the feature or function of the component as is necessary or desired in use of the apparatus. To the extent that the term “operatively connected” is used in the specification or the claims, it is intended to mean that the identified components are connected in a way to perform a designated function. As used in the specification and the claims, the singular forms “a,” “an,” and “the” include the plural. Finally, where the term “about” is used in conjunction with a number, it is intended to include ±10% of the number. In other words, “about 10” may mean from 9 to 11.

As stated above, while the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art, having the benefit of the present application. Therefore, the application, in its broader aspects, is not limited to the specific details, illustrative examples shown, or any apparatus referred to. Departures may be made from such details, examples, and apparatuses without departing from the spirit or scope of the general inventive concept.

What is claimed is:

1. An agricultural tire, comprising:
a toroidal tire structure having a tread portion, a pair of bead portions, and opposite sidewall portions, and further having reinforcing plies; wherein:
the toroidal tire structure contains vulcanized rubber in the amount of about 90 percent or more by weight; and
the plies include high strength plies containing cords that are formed of yarns, including polyamide yarns, and that have individual cord tensile strengths within a range of about 400 N to about 700 N.

2. An agricultural tire as defined in claim 1, wherein the plies include only the high strength plies.

3. An agricultural tire as defined in claim 1, wherein the high strength plies contain only cords that are formed of yarns, including polyamide yarns, and that have individual cord tensile strengths within a range of about 400 N to about 700 N.

4. An agricultural tire as defined in claim 1, wherein the polyamide yarns have deniers within a range of about 1500 to about 1900.

5. An agricultural tire as defined in claim 1, wherein the high strength plies include cords in which the yarns consist of polyamide yarns having deniers within a range of about 1500 to about 1900.

6. An agricultural tire as defined in claim 1, wherein the high strength plies include plies in which all cords are formed of yarns consisting of polyamide yarns having deniers within a range of about 1500 to about 1900.

7. An agricultural tire as defined in claim 1, wherein the high strength plies include one or more radial body plies and one or more circumferential belt plies.

8. An agricultural tire as defined in claim 1, wherein the plies include radial body plies and only a single circumferential belt ply, and the single circumferential belt ply is one of the high strength plies.

9. An agricultural tire, comprising:
a toroidal tire structure having a tread portion, a pair of bead portions, and opposite sidewall portions, and further having reinforcing plies; wherein:
the toroidal tire structure contains vulcanized rubber in an amount of about 90 percent or more by weight; and
the plies include circumferential belt plies having cords at angles of about 74 degrees or more from an axial direction.

10. An agricultural tire as defined in claim 9, wherein the cord angles are within a range of about 74 degrees to about 90 degrees from an axial direction.

11. An agricultural tire as defined in claim 9, wherein the plies include high strength plies containing cords that are formed of yarns, including polyamide yarns, and that have individual cord tensile strengths in a range of about 400 N to about 700 N.

12. An agricultural tire as defined in claim 11, wherein the polyamide yarns have deniers within a range of about 1500 to about 1900.

13. An agricultural tire, comprising:
a toroidal tire structure having a tread portion, a pair of bead portions, and opposite sidewall portions, and further having reinforcing plies; wherein:
the toroidal tire structure contains vulcanized rubber in an amount of about 90 percent or more by weight;
the plies include high strength plies containing cords that are formed of polyamide yarns having deniers within a range of about 1500 to about 1900, and that have individual cord tensile strengths in a range of about 400 N to about 700 N; and
the plies include circumferential belt plies having cords at angles within a range of about 74 degrees to about 90 degrees from an axial direction.

14. An agricultural tire as defined in claim 13, wherein the high strength plies include one or more of the circumferential belt plies.

15. An agricultural tire as defined in claim 13, wherein the high strength plies consist of one or more of the circumferential belt plies.

16. An agricultural tire as defined in claim 13, wherein the high strength plies include one or more radial body plies.

17. An agricultural tire as defined in claim 13, wherein the high strength plies consist of one or more radial body plies.

18. An agricultural tire, comprising:
a toroidal tire structure having a tread portion, a pair of bead portions, and opposite sidewall portions, and further having reinforcing plies; wherein:
the toroidal tire structure contains vulcanized rubber in an amount of about 90 percent or more by weight;
the plies include high strength plies containing cords that formed of yarns, including polyamide yarns having deniers within a range of about 1500 to about 1900, and that have individual cord tensile strengths within a range of about 400 N to about 700 N;
the high strength plies include one or more radial body plies; and
the high strength plies further include one or more circumferential belt plies having cord angles within a range of about 74 degrees to about 90 degrees from an axial direction.

19. An agricultural tire as defined in claim 18, wherein the high strength plies include cords in which the yarns consist of polyamide yarns having deniers within a range of about 1500 to about 1900.

20. An agricultural tire as defined in claim 18, wherein the high strength plies include plies in which all cords are formed of yarns consisting of polyamide yarns having deniers within a range of about 1500 to about 1900.
